(19) United States
(12) Patent Application Publication
(10) Pub. No.: US 2004/0170503 A1
(43) Pub. Date: Sep. 2, 2004

(54) Installing and fixing mechanism for a ceiling fan

(76) Inventor: Yau Yung, Hong Kong (HK)

Correspondence Address: RABIN & BERDO, P.C., Suite 500, 1101 14th Street, N.W., Washington, DC, 20005, US

(21) Appl. No.: 10/770,015

(22) Filed: Feb. 3, 2004

(30) Foreign Application Priority Data
Feb. 28, 2003 (CN) 03201586.0

(51) Int. Cl. F03B 3/12

(52) U.S. Cl. 416/244 R

(57) ABSTRACT

The present invention relates to an installing and fixing mechanism for a ceiling fan, which comprises a first supporting member for fixedly connecting with a ceiling directly or indirectly, and a second supporting member to be joined with the first supporting member and to be fixedly connected with a motor of the ceiling fan. An opening is respectively disposed on two side slanting portions of the first supporting member, along the transverse direction of the first supporting member, so that the corresponding parallel ends of the second supporting member can be respectively pass through the openings and laid on the first supporting member. A “J” shaped hook is installed on the parallel-end of one end of the first supporting member. On the parallel-end of one end of the second supporting member is provided a hole for the hook.

### FIELD OF INVENTION

The present invention relates to a ceiling fan, more specifically, it relates to an installing and fixing mechanism for a ceiling fan.

### BACKGROUND OF THE INVENTION

At present, the fixing mechanism as shown in FIG. 1 is commonly used in the trade for installing a ceiling fan. The mechanism mainly includes a supporting member A and a supporting member B. The longitudinal section profile of the supporting member A looks like a transversely lying bow. The corresponding ends of the supporting member A and the supporting member B are connected together by means of bolts or other connecting members. The middle portion of the supporting member A includes a planar portion for fixedly connecting directly or indirectly with a ceiling and two slanting portions declining respectively downward and outward from two ends of the planar portion. In center of the planar portion, there is a hole for electric wires to pass through it, and there is an opening on one of the slanting portions into which one end of the supporting member B can be inserted and laid against it for ease of connection of the electric wires with the lines of the power supply. The two ends of the supporting member A are two parallel-ends which extend outward in a parallel manner from the slanting portion of the two sides of the middle portion. The free ends of the two parallel-ends extend upward to form flange(s) with respect to the raised middle portion. The supporting member B, which is fixedly connected in advance with the motor of the ceiling fan, has generally two types, one type has the longitudinal profile similar to a transversally lying bow which corresponds to the outer shape of the supporting member A. The other type is of a flat plate, i.e. its middle portion and the two end portions are connected into a planar portion. In the center of the middle portion there is a hole for the electric wires to pass through it and its two longitudinal opposite sides extend upward to form the stopping edges. One end b of the supporting member B can pass through the opening disposed on the slanting portion of the supporting member A and the end b is fixed on the end face of the parallel-end connected with the slanting surface of the opening by bolts while the other end of the supporting member B is fixed beneath the other parallel-end of the supporting member A by bolts.

Generally, before installing the ceiling fan, the supporting member A has been fixed directly or indirectly in advance on a ceiling of a building and the supporting member B has been fixed in advance on a motor. When the ceiling fan is mounted, the installing work is time-consuming and takes a lot of effort, because the electrician or installer must firstly connect the leads of motor which pass through the central hole of the middle planar portion of the supporting member B with the lines of power supply in the building structure which pass through the central hole of the middle planar portion of the supporting member A, then the supporting member A and the supporting member B can be fixedly connected together. In addition, because the supporting members A and B will be connected together with bolts, when the installation is made, before the bolts can be screwed on, the electrician must align the correspondent bolt holes of the two supporting members. Therefore, the work is time-consuming and needs a lot of effort.

SUMMARY OF THF INVENTION

The object of the present invention is to provide an improved fixing and connecting mechanism for the supporting members of a ceiling fan in order to make the installation simple and more rapid, furthermore the installing work can be completed by a single installer. Therefore the manpower and time will be saved and the installing efficiency will be raised.

To this end, the installing and fixing mechanism for a ceiling fan according to the present invention comprises a first supporting member for fixedly connecting with the ceiling directly or indirectly, its longitudinal profile is of the shape of a bow, its raised portion is a planar portion to be joined directly or indirectly with a ceiling, the planar portion firstly slants downward respectively from two outer sides and then extends outward in a parallel manner; and a second supporting member to be joined with the first supporting member and to be fixedly connected with the motor of the ceiling fan; the portion of the second supporting member, which is fixedly connected with the motor of a ceiling fan, is a planar portion, the outer sides of which are respectively two parallel extending portions. An opening is respectively disposed on two slanting portions of the first supporting member, along the transverse direction of the first supporting member, so that the corresponding parallel portions of the second supporting member can be respectively pass through the opening and laid on the first supporting member.

At least one stop member which can prevent the second supporting member from moving to left or right side is disposed on at least one parallel-end faces of said first supporting member.

Two stop members may also be arranged side by side and spaced apart one form the other are provided on the parallel-end face of one end of the first supporting member.

One disassembly stop member is disposed on the parallel-end face of one end of the first supporting member which can prevent the second supporting member from moving upwards, and said disassembly stop member can be moved in longitudinal direction.

The planar portion of the second supporting member, which is fixedly connected with the motor of the ceiling fan, slants firstly upward and toward two outer sides and then extends outward in a parallel manner.

The length of one parallel-end of one end of the second supporting member is longer than that of the other parallel-end of the other end. Alternatively, the lengths of two parallel-ends of the second supporting member are substantively equal.

A lining pad is respectively disposed on two parallel-ends of the second supporting member, by which the second supporting member is in contact with the first supporting member. Alternatively, a pad is respectively disposed on the parallel-end faces of the second supporting member, by which the first supporting member is in contact with the second supporting member.

The parallel-ends of the second supporting member may also be respectively equipped with a pad sleeve.

Specifically, said lining pads or pads or pad sleeves are preferably made of rubber material.

A “J” shaped hook is installed on the parallel-end of one end of the first supporting member. A corresponding hole is provided on the parallel-end of one end of the second supporting member so as to have the second supporting member hang on the first supporting member by the J shaped hook.

Other aspects of the present invention will be more clearly shown from the following drawings and description of the preferred embodiments.

### BRIEF DESCRIPTION OF DRAWINGS

FIG. 1 is a schematic perspective view of the installing and fixing mechanism for a ceiling fan in a prior art.

FIG. 2 is a plan view of the first supporting member of the installing and fixing mechanism for a ceiling fan according to one embodiment of the present invention.

FIG. 3 is a side view of the first supporting member shown in FIG. 2.

FIG. 4 is a plan view of the second supporting member of the installing and fixing mechanism for the ceiling fan according to one embodiment of the present invention.

FIG. 5 is a side view of the second supporting member shown in FIG. 4.

FIG. 6 is a plan view of the first supporting member of the installing and fixing mechanism for a ceiling fan according to an alternative embodiment of the present invention.

FIG. 7 is a partial section view taking along the line VII-VII shown in FIG. 6.

FIG. 8 is a plan view of the second supporting member of the installing and fixing mechanism for the ceiling fan according to the alternative embodiment of the present invention.

FIG. 9 is a side view of the second supporting member shown in FIG. 8.

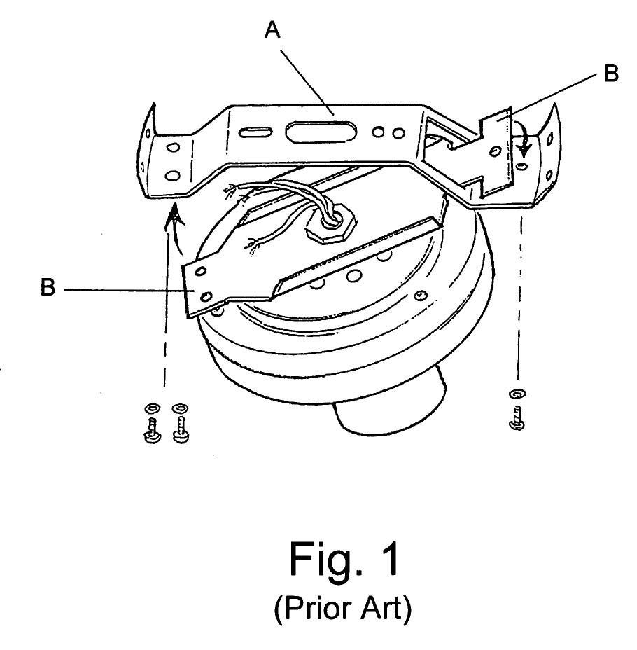

### DETAILED DESCRIPTION OF PREFERRED EMBODIMENT

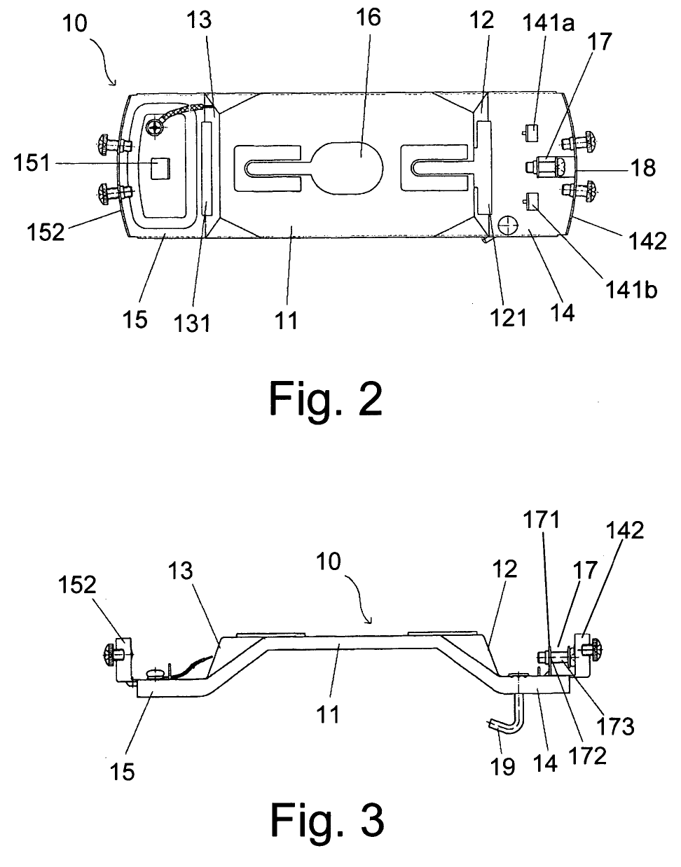

Referring now to FIGS. 2-5, an installing and fixing mechanism for a ceiling fan is shown, which comprises two supporting members 10 and 20.

As shown in FIGS. 2 and 3, the first supporting member 10 is used for fixing the ceiling fan directly or indirectly on a ceiling. It can be seen from the side view that the longitudinal section profile of the first supporting member looks like a transversely lying bow.

The middle portion of the first supporting member 10 includes a planar portion 11 having a central hole 16, a first slanting (ramp) portion 12 and a second slanting portion 13 which respectively extend downward and outward from two sides of the planar portion in a slanting manner. In the present invention, the thickness of two slanting portions is increased so as to enhance the bending strength of the first supporting member 10, as shown in FIG. 2. The first parallel-end 14 which horizontally extends outward from the first slanting portion 12 and the second parallel-end 15 which horizontally extends outward from the second slanting portion 13 respectively constitute two end portions of the first supporting member 10. The free ends of the two end portions extend perpendicularly to the parallel-ends and form the flanges 142 and 152. The height of the two flanges is approximately equal to that of the raised middle portion.

A first opening 121 and a second opening 131 are respectively disposed on the first and second slanting portions 12 and 13 along a transverse direction of the first supporting member so that the two corresponding ends of the second supporting member can pass through them and laid on them. Preferably, the first opening 121 is suitably sized for one end of the second support member to pass through it.

At least one fixed stop member is disposed on end face of the first parallel-end 14 of the first supporting member 10, preferably two fixed stop members 141a and 141b are used which are arranged side by side and spaced apart one from the other. A fixed stop member 151 is disposed on end face of the second parallel-end 15. A distance between the stop member 141a or 141b on the first parallel-end and the stop member 151 of the second parallel-end is slightly greater than the longitudinal length of the second supporting member 20.

A disassembly stop member 17 is further disposed on the end face of the first parallel-end 14 or the second parallel-end face 15. Said stop member 17 includes a support 171 having a longitudinal screw hole 172 and a screw blot 173 matched with the screw hole 172. Said disassembly stop member is preferably disposed between the two stop members 141a and 141b on the first parallel-end 14 of the first supporting member 10. An opening 18 is disposed on the flange 142 of the parallel-end 14. Said opening 18 is aligned with the screw hole 172 of the disassembly stop member 17.

More specifically, the first supporting member 10 further includes a hook 19 which is arranged on first parallel-end 14 or on the second parallel-end 15. In the present embodiment, the hook is “J” shape and is disposed near the side edge of the first parallel-end 14. Said “J” shaped hook 19 is fixed substantially on the first parallel-end 14 by means of riveting, welding or screwing.

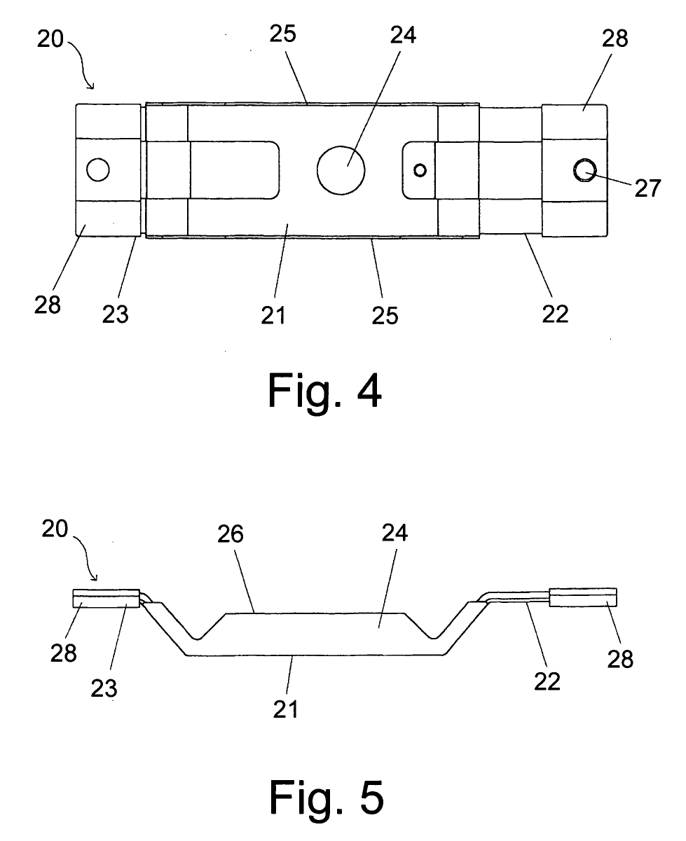

As shown in FIGS. 4 and 5, the second supporting member 20 may be fixedly connected together with a motor of a ceiling fan (not shown). It can be seen from FIG. 5, the longitudinal profile of the second supporting member is also of a shape of transversely lying bow. In middle of the second supporting member, there is a planar portion 21 having a central hole 24, from the two sides of which, two slanting portions are extended upwards. Two longitudinal side edges of the planar portion 21 extend upward approximately perpendicular to the portion and form stop edges 25. A third parallel-end 22 and a forth parallel-end 23 which extend horizontally outward from the two slanting portions respectively constitute two end portions of the second supporting member 20.

The length of one parallel-end of the second supporting member 20 is longer than that of the other parallel-end. In this embodiment, the length of the third parallel-end 22 is longer than that of the forth parallel-end 23. A hole 27 can be disposed on the third parallel-end 22 or on the forth parallel-end 23 so that the “J” shaped hook 19 of the first supporting member 10 can be passed through it. In this embodiment, the hole 27 is disposed on the longer end, i.e. on the third parallel-end 22, near the middle position of the end edge.

The planar portion 21 in the middle of the second supporting member 20, two slanting portions and the two stop edges 25 jointly constitute a semi-closed groove 26.

When installing and fixing the ceiling fan, firstly making the second supporting member 20 fixed in advance on the motor of the ceiling fan hang on the “J” shaped hook 9 through the hole 27 on the third parallel-end 22. The “J” shaped hook 9 is disposed on the first parallel-end of the first supporting 10 which has been already fixed on the ceiling. Then, connecting together the electric wires which pass through respectively the central holes of the middle planar portions of the first and second supporting members can be made with the hands freed from the motor supported originally with the hands.

After joining the electric wires together, the second supporting member 20 connected with the motor is taken out of the “J” shaped hook 19, then making the longer end of the second supporting member, i.e. the third parallel-end 22, pass through the opening 121 on the slanting portion 12 of the first supporting member 10 from below upwards, then making the other end 23 of the second supporting member 20 pass through the opening 131 on the second slanting portion 13 of the first supporting member 10. At this time, the two ends 22, 23 are respectively supported by the end faces of the two ends 14, 15 of the first supporting member 10, while the electric wires joined together can be stored in the groove 26. Afterwards, the second supporting member is pushed slightly toward the second parallel-end of the first supporting member to make it push into the area between the stop members 141a, 141b on the first parallel-end of the first supporting member 10 and the stop member 151 on the second parallel-end, this can prevent the second supporting member 20 from shifting (moving) to left or to right side. Finally, a tool such as a screw driver is used to pass through the opening 18 on the flange 142 of the first parallel-end 14 of the first supporting member 10 to screw the bolt 173 placed in the screw hole 172 of the support 171 of the first parallel-end 14, so that the bolt 173 is located on the third parallel-end 22 of the second supporting member. The height of the bolt 173 can just press against the third parallel-end 22 down of the second supporting member, which can prevent the second support member from moving upward. Of course, other types of the stop member can also be used.

In order to prevent the first supporting member 10 and the second supporting member 20 from producing noise or shifting due to the vibration and the friction during use, a pad sleeve 28 can be placed or fitted over each of the two parallel-ends of the first supporting member, or a lining pad can be arranged respectively between two parallel-ends of the second supporting member and the corresponding contact portion of the first supporting member (not shown in Figs). This can prevent vibration, noises as well as shifting.

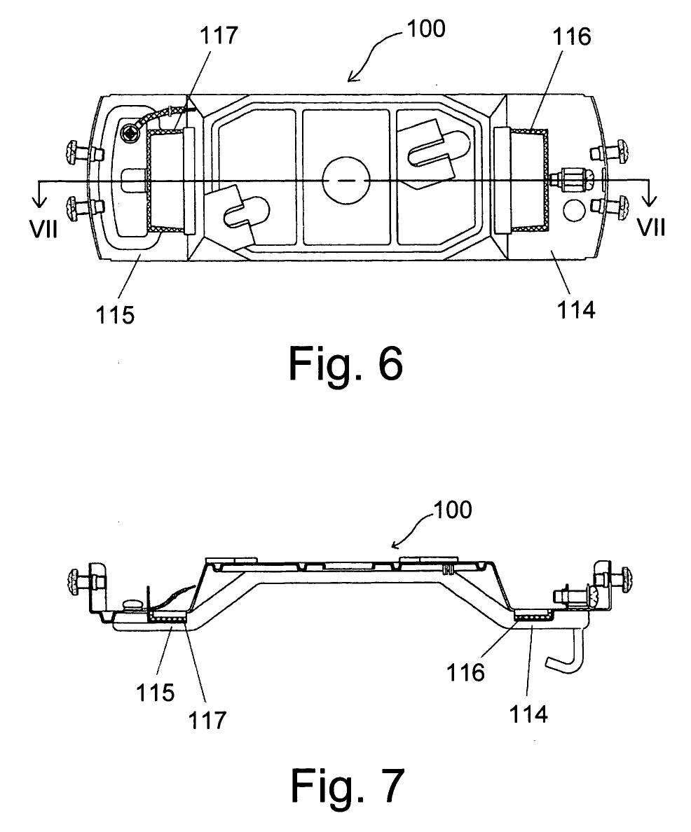

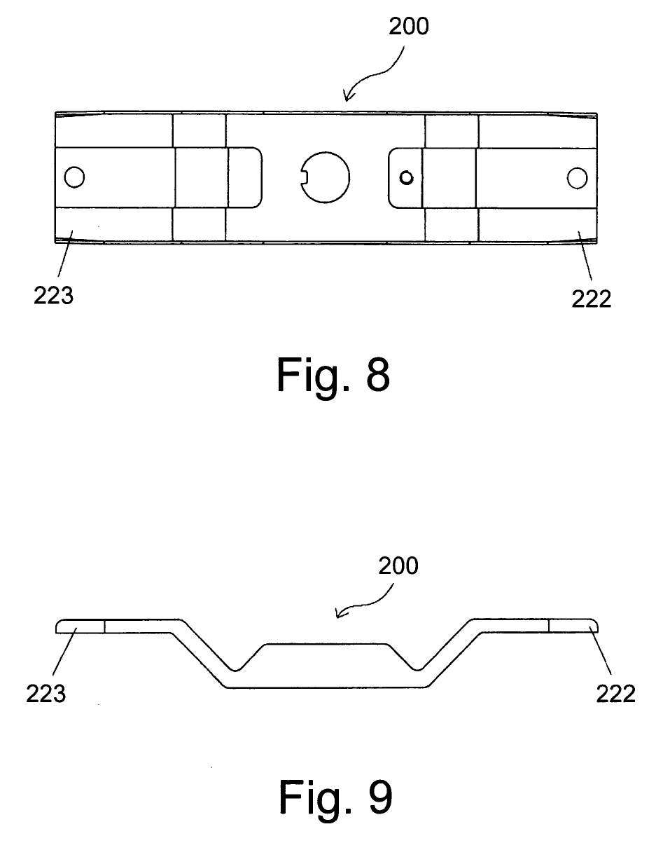

FIGS. 6-9 show an alternative embodiment according to the present invention, which comprises two supporting member 100 and 200.

In this embodiment, the installing and fixing mechanism is similar to that of the first embodiment except for some small modification.

As shown in FIGS. 6-9, the first and second supporting members 100, 200 also include a middle portion, two slanting portions and parallel-ends 114, 115, 222, 223.

An opening is respectively disposed on the two slanting portions of the first supporting member 100, along the transverse direction of the first supporting member, so that the corresponding parallel ends 222, 223 of the second supporting member 200 can be respectively passed through the opening and laid on the first supporting member 100.

The main difference between the first and second embodiments is that the length of two parallel-ends 223 and 224 of the second supporting member is substantively equal.

In addition, pads 116, 117 preferably made of rubber material are provided on the parallel-end faces of the first supporting member 100, by which he first supporting member is in contact with the second supporting member.

With use of the installing and fixing mechanism for the ceiling fan according to the present invention, the installing (installation) of the ceiling fan will be more simple and rapid (short cut), at the same time, vibration and noises can be prevented.

Although the preferred embodiment according to the present invention has been described in detail as above, to the skilled persons in the art, within the design ideas and conception of the present invention, various variations and changes can still be made to the preferred embodiment, it could be said that all such possible variations and changes will be fallen into the protection scope of present invention.

What is claimed is:

1. An installing and fixing mechanism for a ceiling fan, which comprises:
a first supporting member for fixedly connecting with a ceiling directly or indirectly, its longitudinal profile is of the shape of a bow, its raised portion is a planar portion to be joined directly or indirectly with the ceiling, the planar portion firstly slants respectively downward and toward two outer sides and then extends outward in a parallel manner, and
a second supporting member to be joined with the first supporting member and to be fixedly connected with a motor of the ceiling fan; a portion of the second supporting member, which is fixedly connected with the motor of the ceiling fan, is a planar portion, outer sides of which respectively are two parallel extending portions,
wherein an opening is respectively disposed on the two slanting portions of the first supporting member, along the transverse direction of the first supporting member, so that the corresponding parallel ends of the second supporting member can be respectively pass through the openings and laid on the first supporting member.

2. The installing and fixing mechanism of claim 1 wherein on at least one parallel-end face of the first supporting member is respectively disposed at least one fixed stop member which can prevent the second supporting member from moving to the left or right side.

3. The installing and fixing mechanism of claim 2 wherein two fixed stop members arranged side by side and spaced apart one from the other are provided on the parallel-end face of one end of the first supporting member.

4. The installing and fixing mechanism of claim 1 wherein a disassembly stop member is disposed at least on the parallel-end face of one end of the first supporting member which can prevent the second supporting member from moving upward, and said disassembly stop member can be moved in longitudinal direction.

5. The installing and fixing mechanism of claim 1 wherein the planar portion of the second supporting member which is fixedly connected with the motor of the ceiling fan slants upward and toward the two outer sides and then extends outward in a parallel manner.

6. The installing and fixing mechanism of claim 3 wherein the length of one parallel-end of said second supporting member is longer than that of the other parallel-end.

7. The installing and fixing mechanism of claim 6 wherein a lining pad is respectively disposed on two parallel-ends of the second supporting member, by which the second supporting member is in contact with the first supporting member.

8. The installing and fixing mechanism of claim 1 wherein the length of two parallel-ends of said second supporting member is substantively equal.

9 The installing and fixing mechanism of claim 8 wherein a pad is respectively disposed on two parallel-end faces of the first supporting member, by which the first supporting member is in contact with the second supporting member.

10. The installing and fixing mechanism of claim 1 wherein the parallel-ends of the two ends of the second supporting member are respectively equipped with a pad sleeve.

11. The installing and fixing mechanism of claim 7 wherein said lining pads are made of rubber material.

12. The installing and fixing mechanism of claim 9 wherein said pads are made of rubber material.

13. The installing and fixing mechanism of claim 10 wherein said pad sleeves are made of rubber material.

14. The installing and fixing mechanism of claim 1 wherein a “J” shaped hook is installed on the parallel-end of one end of the first supporting member.

15. The installing and fixing mechanism of claim 14, wherein on the parallel-end of one end of the second supporting member is provided a hole for the “J” shaped hook.
